(19) United States
(12) Patent Application Publication
(10) Pub. No.: US 2026/0303001 A1
(43) Pub. Date: Oct. 1, 2026

(54) APPARATUS AND METHODS FOR SOLAR ARRAYS HAVING MULTIPLE SOLAR PANELS, FOR NATUREMOUNT APPLICATIONS

(71) Applicant: 1st Avenue Nova, LLC, Los Angeles, CA (US)

(72) Inventor: Thomas BUTTGENBACH, Santa Monica, CA (US)

(73) Assignee: 1st Avenue Nova, LLC, Los Angeles, CA (US)

(21) Appl. No.: 19/630,962

(22) Filed: Mar. 27, 2026

Related U.S. Application Data
(60) Provisional application No. 63/778,722, filed on Mar. 27, 2025.

(51) Int. Cl. H02S 20/20

(52) U.S. Cl. CPC H02S 20/20

(57) ABSTRACT

In an embodiment, a solar array has a non-planar configuration and includes a first plurality of solar modules and a second plurality of solar modules coupled to the first plurality of solar modules. Each solar module from the first plurality of solar modules and each solar module from the second plurality of solar modules has a planar configuration and has a first side and a second side shorter than the first side. For each solar module from the first plurality of solar modules, (1) the first side of that solar module is fixedly coupled to and along a substantial entirety of the first side of a solar module from the second plurality of solar modules, and (2) the second side of that solar module is fixedly coupled to and along a substantial entirety of a side of an adjacent solar module from the first plurality of solar modules.

### CROSS-REFERENCE TO RELATED APPLICATION

This application claims priority to U.S. Provisional Patent Application No. 63/778,722, filed Mar. 27, 2025 and titled “Apparatus and Methods for Solar Arrays Having Multiple Solar Panels, for Naturemount Applications,” the entirety of which is incorporated by reference herein.

### FIELD

The present disclosure relates to a non-planar solar array having multiple solar panels, and methods of assembling such a solar array.

### BACKGROUND

Known solar arrays formed by multiple solar panels are typically formed in certain orientations. Such orientations, however, are fairly limited in variations and relatively flat, which has limited effectiveness in water runoff after rain. Thus, a need exists for configuring solar array into various orientations including orientations that have steeper arrangements with more effective water runoff.

### SUMMARY

In an embodiment, an apparatus includes a first plurality of solar modules. Each solar module from the first plurality of solar modules has a planar configuration and has a first side and a second side shorter than the first side. The apparatus further comprises a second plurality of solar modules coupled to the first plurality of solar modules. Each solar module from the second plurality of solar modules has a planar configuration and has a first side and a second side. For each solar module from the first plurality of solar modules, (1) the first side of that solar module is fixedly coupled to and along a substantial entirety of the first side of a solar module from the second plurality of solar modules, and (2) the second side of that solar module is fixedly coupled to and along a substantial entirety of a side of an adjacent solar module from the first plurality of solar modules. The first plurality of solar modules and the second plurality of solar modules collectively defines a solar array having a non-planar configuration.

In an embodiment, a method includes, for each solar module from a first plurality of solar modules, fixedly coupling along a substantial entirety of a first side of that solar module and a first side of a solar module from a second plurality of solar modules. Each solar module from the first plurality of solar modules has a planar configuration and has a first side and a second side shorter than the first side. Each solar module from the second plurality of solar modules has a planar configuration and has a first side and a second side. For each solar module from the first plurality of solar modules, the method further includes fixedly coupling along a substantial entirety of the second side of that solar module to a side of an adjacent solar module from the first plurality of solar modules, to collectively define a solar array having a non-planar configuration.

### BRIEF DESCRIPTION OF THE DRAWINGS

FIGS. 1A-1B are schematic diagrams of a solar module assembly, according to embodiments.

FIGS. 2A-2B show a top view and a side view, respectively, of a symmetric landscape configuration of a solar array, according to an embodiment.

FIG. 3 shows a perspective view of a solar array in which an inverted “V” shape is created by affixing the solar panel frames to each other at a 90-degree angle, according to an embodiment.

FIGS. 4A-4B show an exploded top view and a side view, respectively, of a portrait-landscape configuration of a solar array, according to an embodiment.

FIGS. 5A-5B show a top view and a side view, respectively, of an asymmetric portrait-landscape configuration of a solar array, according to an embodiment.

FIG. 6 shows a side view of a solar array in which an inverted “V” shape is created by affixing the solar panel frames to an angled extrusion placed between them, according to an embodiment.

FIGS. 7A-7B show a top view and a side view, respectively, of an asymmetric portrait-landscape configuration of a solar array, according to another embodiment.

FIG. 8 is a side view of a solar array in which an inverted “V” shape is created by affixing the solar panel frames to an angled extrusion placed between them, according to an embodiment.

FIG. 9 shows a perspective view of a solar array in which an inverted “V” shape is created by affixing the solar panel frames at an angle greater than 90 degrees, according to some embodiments.

FIG. 10 shows a perspective view of a solar array in which the solar panel frames are coupled to one another with one or more couplers, according to embodiments.

FIG. 11 shows a perspective view of a solar array in which the solar panel frames are coupled to one another with one or more couplers, according to embodiments.

FIG. 12 shows a perspective view of a solar array in which the solar panel frames are coupled to one another with a structure including one or more hinges or clips, according to embodiments.

FIG. 13 shows a perspective view of a solar array including one or more ground attachments, according to embodiments.

FIG. 14 shows a schematic of a metal frame of a solar array (left) and a close-up cross-section of layers of the metal frame (right), according to some embodiments.

FIG. 15 shows a cross-section of a solar module frame, according to embodiments.

FIG. 16 is a flow chart of an example method of forming a non-planar solar array, according to embodiments.

### DETAILED DESCRIPTION

Embodiments described herein relate to arrangements of solar modules (or solar panels) into a solar array that is configured to generate power more uniformly/evenly throughout the day, and to facilitate water runoff. In some embodiments, a solar array can include a plurality of solar modules arranged in a specific geometry (e.g., a non-planar geometry). In some embodiments, the solar array can include one or more first solar modules forming a first surface and one or more second solar modules forming a second surface. For example, the solar array can include a first set of solar modules configured to be coupled together to form the first surface and a second set of solar modules configured to be coupled together to form the second surface. The first surface and the second surface can be coupled (e.g., fixed, supported, fastened, molded, etc.) to one another to define a predetermined angle therebetween. The apex of the angle can face upwards (e.g., towards the sky) such that the solar array forms an inverted “V” configuration. In some embodiments, the solar array can include racks configured to hold the solar panels in an inverted “V” configuration (e.g., having flat segments/sides on either side of an apex line) for water runoff. The apex line can refer to the axis along the top of the inverted “V.”

The inverted “V” is not solely useful for running off water. If the axis of the “V” (i.e., the apex line) is oriented north-south, the east-tilted solar modules can generate more power in the earlier morning (e.g., sunrise to before noon) than they would have if they were aimed directly upward; and the west-tilted solar modules can generate more power in the afternoon (e.g., after noon to sunset). During mid-day, around noon, both sets of solar modules (e.g., east-tilted and west-tilted) produce less power than they would have, if aimed directly upward. Flat solar assemblies that are aimed directly upward, however, generate a spike in the power profile throughout the day with a sharp increase in power at mid-day. By contrast, a solar rack with an inverted “V” configuration produces a flatter or more stable power profile throughout the day than the flat solar rack. Although total energy production in an angled solar array may be slightly lower than the flat solar rack, a flatter power profile, with a lower peak value, improves the match between power production and typical electrical load profiles, thereby reducing the need for (costly) energy storage capacity.

The individual solar panels each can be substantially planar and connected together in ways to produce non-planar, for example, inverted “V” shapes. The individual solar panels can be substantially planar in the sense that the solar panels vary a small amount, for example, due to manufacturing variances and/or due to flexing (bending, twisting, etc.) notwithstanding the rigidity of the solar panels.

As used herein, the term “NatureMount” can refer, by way of example, to a solar module mounting structure that reduces or minimizes a grading of a terrain, a levelling of a terrain, and/or an amount/presence of a foundation in connection with the placement of the solar module(s) on natural land (e.g., earth). Stated another way, NatureMount can refer to a system that facilitates placement of solar module(s) on natural land with a reduced amount of preparation of the natural land location, as contrasted with known systems/methods.

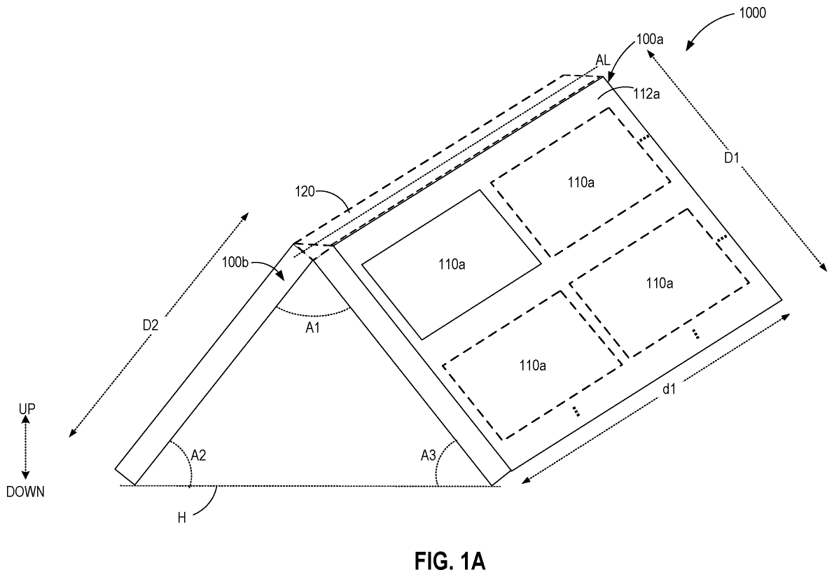

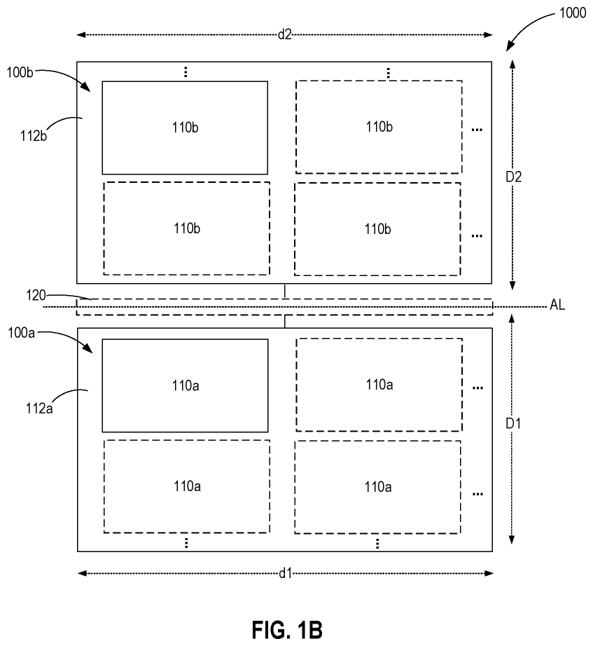

FIGS. 1A-1B show an isometric view and a top plan view, respectively, of a “NatureMount” solar array 1000, according to some embodiments. In FIGS. 1A-1B, dashed lines are intended to show components that are optional. Dotted lines are intended to show axes or clarify dimensions and are not included in the structure of the assembly. The solar array 1000 can include a first set or plurality of solar modules (or panels) 110a and a second set or plurality of solar modules (or panels) 110b. In some embodiments, each solar module 110a, 110b can have a first side and a second side shorter than the first side. Each of the first set of solar modules 110a and the second set of solar modules 110b can have a substantially planar configuration. In some embodiments, the first set of solar modules 110a and the second set of solar modules 110b can be coupled to one another such that the solar array 1000 forms a non-planar configuration. The first set of solar modules 110a and the second set of solar modules 110b can be coupled to one another to form an angle a therebetween. Therefore, the solar array 1000 can form an inverted “V” shape with an apex line AL formed at an apex of the “V” along the length of the solar array 1000. The apex of the angle can face upwards (e.g., towards the sky). The first set of solar modules 110a can include a plurality of solar modules 110a arranged in a grid pattern or an array, and the second set of solar modules 110b can include a plurality of solar modules 110b (shown in FIG. 1B) arranged in grid pattern or array. The first set of solar modules 110a can be supported in a planar configuration by a first frame 112a (e.g., rack, mount, support member, etc.) to form a first solar panel assembly 100a, and the second set of solar modules 100b can be supported in a planar configuration by a second frame 112b to form a second solar panel assembly 100b. In some embodiments, the first set of solar modules 110a can be directly coupled to one another in a planar configuration (e.g., with or without a frame 112a) to form the first solar panel assembly 100a, and the second set of modules 110b can be directly coupled to one another in a planar configuration (e.g., with or without frame 112b) to form the second solar panel assembly 100b. In some embodiments each module of the first set of solar modules 110a can have a first side and a second side, the second side being shorter than the first side. In some embodiments, each module of the second set of solar modules 110b can have a first side and a second, the second side being shorter than the first side.

In some embodiments, the plurality of solar modules 110a, 110b can be oriented in a landscape orientation or a portrait orientation. In some embodiments, the plurality of solar modules 110a, 110b can be mounted to the frame 112a, 112b in the landscape orientation or the portrait orientation. The landscape orientation can refer to an orientation in which the solar module is oriented with the longer side (e.g., the first side) or dimension configured to run parallel to the horizon H and the shorter dimension (e.g., the second side) configured to form an angle A2 or A3 relative to the horizon (as shown in FIG. 1A). Portrait orientation can refer to an orientation in which the solar module is oriented with the shorter dimensions configured to run parallel to the horizon H and the longer dimension configured to form the angle A2 or A3 relative to the horizon H (not shown in FIG. 1A). In some embodiments, the plurality of solar modules 110a in the first set of solar panels can have the same arrangement and/or orientation as the plurality of solar panels 110b in the second set of solar panels. Therefore, the solar panel assembly 100a can have a first dimension D1 that is equivalent to a corresponding first dimension D2 of the second solar panel assembly 100b, and a second dimension d1 that is equivalent to a corresponding second dimension d2 of the second solar panel assembly 100b. In other words, the frames 112a, 112b can be configured to accommodate a common solar module size. In some embodiments, the arrangement of the solar panels in each of the solar panel assemblies 100a, 100b can be different. For example, the set of solar modules 110a in the first solar panel assembly 100a can be oriented in the landscape configuration and the second set of solar modules 110b can be oriented in the portrait configuration, or vice versa. In some embodiments, the frame 112a can support the first set of solar panels 110a in the landscape configuration and the second frame 112b can support the second set of solar modules 110b in the portrait configuration, or vice versa. Therefore, the dimensions D1, d1 of the first set of solar modules 100a and the dimensions D2, d2 of the second set of solar modules 100b can be different. In some embodiments, each solar module from the first plurality of solar modules can have a first size, and each solar module from the second plurality of solar modules can have a second size different from the first size.

In some embodiments, the solar array 1000 as a whole can be positioned in a predetermined orientation. For example, the solar array 1000 can be configured such that the first set of solar modules 100a is eastern facing and the second set of solar modules 100b is western facing, or vice versa. In some embodiments, the orientation of the solar array 1000 in combination with the non-planar configuration can facilitate more even (i.e., uniform) power generation throughout a day than a flat panel assembly. For example, during the morning hours, the eastern-facing solar modules can have higher sun exposure than the western-facing solar modules, during the mid-day hours both solar modules can have substantially similar sun exposure, and during the afternoon hours the western-facing solar modules can have higher sun exposure than the eastern-facing solar modules. Additionally, total power generated with this configuration more closely aligns with power needs than a flat solar array.

In some embodiments, the first set of solar modules 100a (e.g., the first frame 112a of the first set of solar modules 100a) can be coupled to the second set of solar modules 100b (e.g., the second frame 112b of the second set of solar modules 100b) by any suitable mechanism. In some embodiments, the first set of solar modules 110a can be coupled to the second set of solar modules 110b directly without an intervening component. For example, the first set of solar modules 110a can be coupled to the second set of solar modules 110b via a butt join (e.g., 90-degree butt join) such that the solar array 1000 forms a vertex without an intervening component. In some embodiments, the first solar panel assembly can form an angle A3 with the horizon H such that the solar panel assembly 100a supports the second solar panel assembly 100b at the predetermined angle A2 (e.g., without a fastener or coupling mechanism), or vice versa. In some embodiments, solar array 1000 can optionally include a spacer (e.g., fastener, coupler, etc.) 120 configured to couple the first set of solar modules 100a to the second set of solar modules 100b. For example, the solar array 1000 can include an angled extrusion 120 (e.g., a metal angle) configured to couple the first set of solar modules 110a (or the frame 112a) to the second set of solar modules 110b. The angled extrusion 120 can include a triangular, square, rectangular, diamond, or any other suitable cross-section. In some embodiments, the angle extrusion can be configured to fasten the solar modules 100a, 100b at a predetermined angle (e.g., angle A1). In some embodiments, the fastener or coupler 120 can include one or more hinges, fasteners, etc. configured to be affixed along one or more portions along the length d1, d2 of the first and second set of solar modules 100a. In some embodiments, the first set of solar modules 100a can be coupled to the second set of solar modules 100b along substantially an entirety of the length (e.g., d1) of the first set of solar modules 100a and an entirety of the length (not labeled) of the second set of solar modules 100b. In some embodiments, when the first set of solar modules 110a are oriented in a different orientation than the second set of solar modules 110b, one of the first solar panel assembly 100a or the second solar panel assembly 100b may have an overhang portion not affixed.

In some embodiments, the first side of a solar module 110a is fixedly coupled to a first side of the spacer 120 that has a second side fixedly coupled to the first side of a solar module 110b from the second set of solar modules. In some embodiments, a side view of the spacer 120 can have an interior angle that defines an interior angle of the solar array A1.

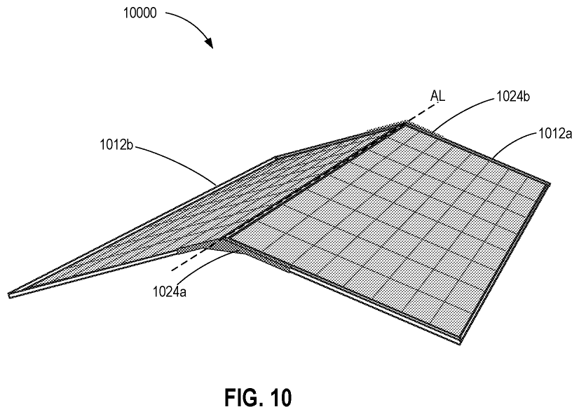

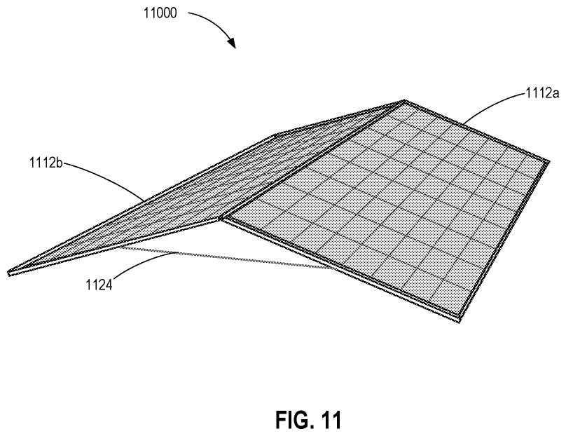

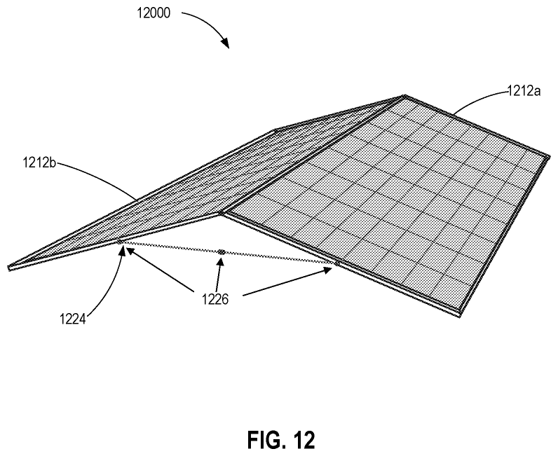

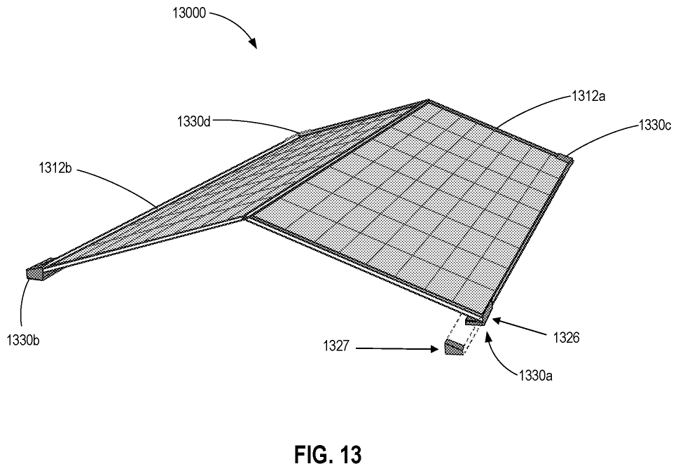

In some implementations, fixedly attaching the first set of solar modules 100a and the second set of solar modules 100b can cause bending moments at the apex (AL) to be undesirably large resulting in twisting of the frame(s), peeling away of the adhesive or coupler joining the frames, and/or pulling out of fasteners joining the frames, for example. Bending moments at the apex AL can become undesirably large as a result of the solar array 1000 being lifted or supported by its outer ends (e.g., the edge of the frames 112a, 112b opposite the apex AL). The forces at the outer ends of the solar array 1000 that act in directions that cause splaying or closing of the solar array 1000 if the first set of solar modules 100a and the second set of solar modules 100b were not fixed instead generate the bending moment at the apex. In some implementations, the fastener or coupler 120 can be configured to couple or clamp onto a portion of a side of each frame 112a, 112b to couple the first set of solar modules 100a and the second set of solar modules 100b. In some implementations, the fastener or coupler 120 may extend along a portion of the second side (or edge) of each frame 112a, 112b that define the inverted “V” to secure the frames at a predetermined angle, as described further with respect to FIG. 10. As such, the fastener or coupler 120 may not run along the length of the apex AL. In some implementations, the solar array 1000 can include a first angled coupler that couples to the first side of the first set of solar modules (e.g., shown by dimension d1) and the first side of the second set of solar modules (e.g., shown by dimension d2), and the solar array 1000 can additionally or alternatively include a second coupler (or fastener, support structure, etc.) configured to couple to a portion of the second side (e.g., shown by dimension D1 and D2) of the first and second set of solar modules 110a, 110b. In some implementations, the solar array 1000 may only have couplers that couple to portions (e.g., less than the entireties) of the sides or edges of the sets of solar modules (or frames) that define the inverted “V.” The fastener or coupler 120 can include a hinge(s) or the like. In some implementations, the fastener or coupler 120 can be configured to limit “splaying” of the tent, by reducing the bending moment at the apex once the tent is installed. In some embodiments, the fastener or coupler can include a mechanical attachment that spans across an opening of the tent (e.g., the base of the tent), as described further in FIGS. 11-12. In some embodiments, the support structure can include ground attachments that hold the bottoms in place, as described further in FIG. 13.

In some embodiments, the first side of the first solar panel assembly 100a having the longer dimension d1 can be coupled to the first side of the second solar panel assembly 100b having the longer dimension d2. In some embodiments, the second side of the first solar panel assembly 100a with the shorter dimension D1 can be coupled to the first side of the second solar panel assembly 100b having the longer dimension d2, or vice versa. In some embodiments, the dimensions of the first solar panel assembly 100a and the second solar panel assembly 100b and the side along which they are attached can impact an interior angle formed by the solar panel assemblies 100a, 100b.

In some embodiments, the predetermined angle A1 can be any suitable angle between about 60 degrees and about 150 degrees, inclusive of all values and subranges therebetween. In some embodiments, the predetermined angle A1 can be between about 90 degrees and around 135 degrees, inclusive of all values and subranges therebetween. In some embodiments, the predetermined angle A1 of the solar array 1000 can be configured to promote water run-off while also enabling adequate sun exposure, and therefore, power generation. In some embodiments, the angles A2 and/or A3 can be in a range between about 10 degrees to about 60 degrees, inclusive of all values and subranges therebetween. In some embodiments, the angles A2 and A3 can be equivalent to one another (e.g., when the first set of solar modules 100a are arranged in the same orientation as the second set of solar modules 110b). In some embodiments, the angles A2 and A3 can be different from one another (e.g., when the first set of solar modules 110a are arranged in an orientation that is different than that of the second set of solar modules 110b).

In some embodiments, the solar array when positioned on a substantially planar surface has a first interior angle A1, a second interior angle A2 and a third interior angle A3, the second interior angle is less than the first interior angle, the third interior angle is less than the first interior angle and the second interior angle. In some embodiments, the solar array 1000 when positioned on a substantially planar surface has a first interior angle A1, a second interior angle A2 and a third interior angle A3, the first interior angle A1 is substantially 90 degrees, the second interior angle A2 is not less than 45 degrees, and the third interior angle A3 is not greater than 45 degrees. In some embodiments, the first interior angle A1 is substantially 90 degrees, the second interior angle A2 is less than 45 degrees, and the third interior angle A3 is greater than 45 degrees. In some embodiments, the first interior angle A1 is substantially 90 degrees, the second interior angle A2 is about 33 degrees, and the third interior angle is about 56 degrees. In some embodiments, the first interior angle A1 is substantially 135 degrees, the second interior angle A2 is 18 degrees, and the third interior angle A3 is greater than 27 degrees.

In some implementations, the first set of solar modules 110a and/or the second set of solar modules 110b can each have any suitable number of solar modules therein. For example, the first set of solar modules 110a and/or the second set of solar modules 110b can each have between about 1 solar module and about 9 solar modules, inclusive of all values and subranges therebetween. In some implementations, each of the first set of solar modules 110a and/or the second set of solar modules 110b can include between 2 solar modules and 4 solar modules, inclusive of all values and subranges therebetween.

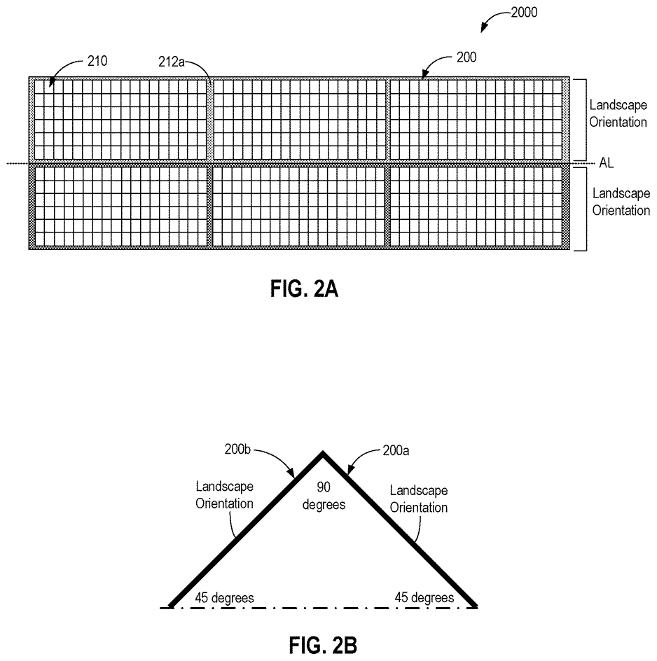

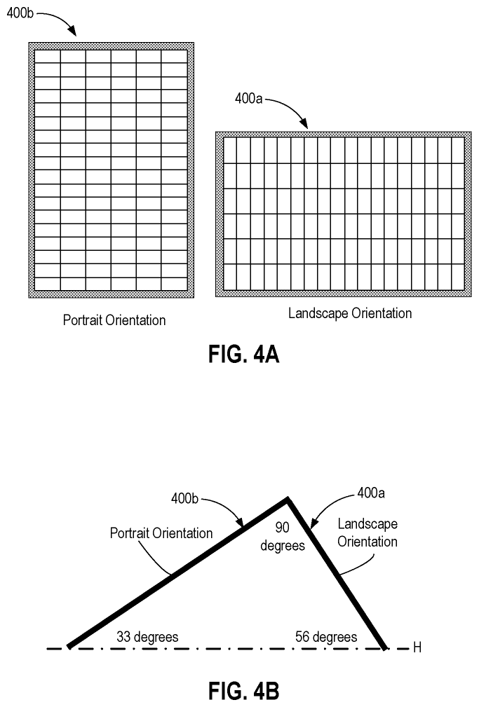

FIGS. 2A-2B shows an example of six solar modules mounted on a frame 212 in a “landscape” orientation. Therefore, each solar module is oriented with the longer dimension configured to run parallel to the horizon and the shorter dimension configured to form an angle relative to the horizon (shown as a dashed-dotted line). As shown in FIG. 2B, a first frame and a second frame can be joined at a 90-degree angle along the apex to create a “tent”/inverted “V” structure with the solar modules tilted at 45 degrees to the horizon on both sides. In some embodiments, the solar modules shown in FIG. 2A can be consistent, for example, with typical 108-cell 400 W solar modules, with solar module dimensions 1.72×1.13 m. It should be appreciated that the 90-degree angle and the two 45-degree angles shown in FIG. 2B are examples of interior angles in the sense that the angles are interior to the triangle defined from the side view shown in FIG. 2B (including the horizontal line completing the triangle shown in FIG. 2B). FIGS. 4B, 5B, and 7B discussed below also describe angles that can be referred to herein as interior angles. Certain aspects of the solar array shown in FIGS. 2A-2B can be structurally and/or functionally similar to the solar array described in FIGS. 1A-1B, and therefore, certain aspects are not described herein with respect to FIGS. 2A-2B.

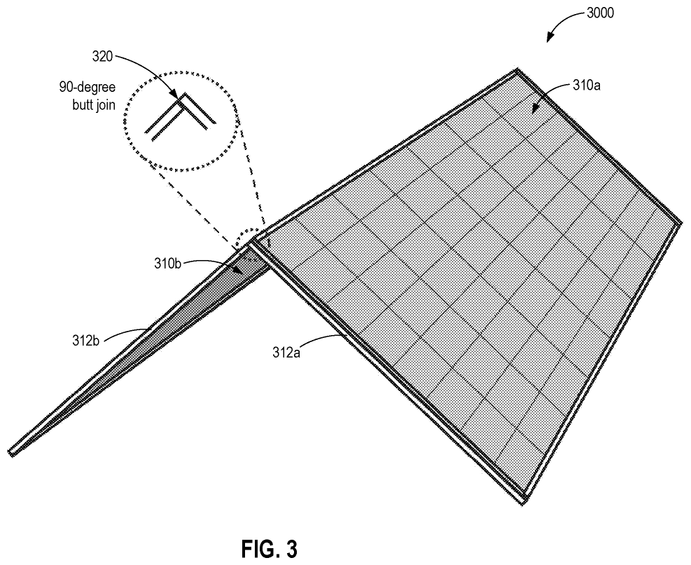

FIG. 3 shows an example of a solar array 3000, in which an inverted “V” shape is created by affixing solar panel frames 312a, 312b to each other at a 90-degree angle. This enables the solar panel frames 312a, 312b to be joined flat-surface-to-flat-surface without any additional parts (e.g., without an intervening component). For example, the solar panel frames 312a, 312b can form a 90-degree butt join 320. Although FIG. 3 shows each solar panel frame 312a supporting one solar module 310a, it should appreciated that each frame 312a, 312b can include any suitable number of solar modules. In some embodiments, the solar panel frames 312a, 312b can include a plurality of solar modules arranged in an array or grid.

In some embodiments, the solar panel frames can be affixed to each other, for example, along a substantially entirety of the affixed sides of the solar panel frames. The solar panel frames can be affixed along a substantially entirety of affixed sides in the sense that the solar panel frames can be affixed along the entirety or almost all of the entirety (e.g., 90%, 95% or 99% of the length of the frame) of affixed sides. The solar panels can be affixed along almost all of the entirety but not the actual entirety of the affixed side, for example, due to imperfections to the attachment mechanism or the installation of the attachment mechanism (e.g., multiple hinges with a small amount of space between adjacent hinges, a piano hinge that does not fully extend across the entire affixed side, etc.).

In a variation, the “V” formed by the solar panel frames can be asymmetric. For example, east-tilted panels can be positioned at a relatively steep angle and the west-tilted panels at a relatively flatter angle. This arrangement may be even more advantageous, in two ways. First, the battery state of charge is typically lowest in the early morning and battery useful life tends to be reduced by spending time at low state of charge, so by having part of the solar array being relatively steeply tilted toward the east, it is possible to re-charge the battery earlier in the morning. Second, interior temperatures (in homes, for example) tend to be at their highest in the mid-afternoon, when power production would peak in the part of the array that is more moderately tilted toward the west. Certain aspects of the solar array shown in FIG. 3 can be structurally and/or functionally similar to the solar array described in FIGS. 1A-1B, and therefore, certain aspects are not described herein with respect to FIG. 3.

In some embodiments, the asymmetry can be, for example, achieved by having the east-facing panels mounted in a landscape orientation while the west-facing panels are mounted in a portrait orientation. FIGS. 4A-4B illustrate an example of such an arrangement. If these solar modules 400a, 400b are set up in a “tent” or inverted-V arrangement, with the solar modules joined at a 90-degree angle, the portrait-oriented solar modules 400a form a 33-degree angle from horizontal H while the landscape-oriented solar modules will be at a 56-degree angle.

This arrangement accomplishes an asymmetric “tent”/inverted-V mounting arrangement without the need for additional mounting elements: the frames of the solar modules serve to hold each other in place. For example, the landscape-oriented solar module 400b can support the portrait-oriented solar module 400b. Certain aspects of the solar array shown in FIGS. 4A-4B can be structurally and/or functionally similar to the solar array described in FIGS. 1A-1B, and therefore, certain aspects are not described herein with respect to FIGS. 4A-4B.

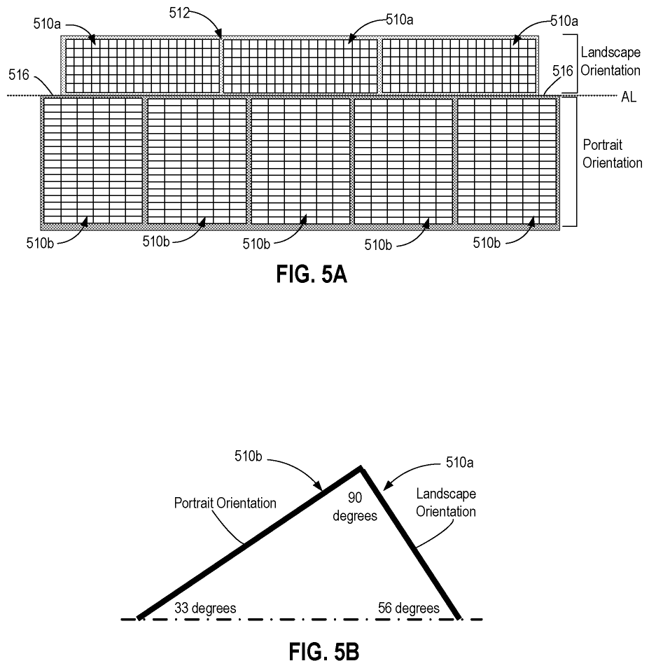

FIG. 5A shows a plan view of a rack 512 (or frame) composed of a first set of solar modules including modules 510a mounted to the rack 512 in landscape orientation, and a second set of solar modules 510b mounted to the rack 512 in portrait orientation. For example, three solar modules can be oriented in landscape orientation and five solar modules can be oriented in portrait orientation, for a total of eight solar modules in the rack. While FIG. 5A shows the landscape-oriented solar modules look narrower than the portrait-oriented solar modules, while the portrait-oriented solar modules look shorter than the landscape-oriented ones, it should be noted that this is due to the solar modules 510a, 510b being tilted, and the view is a plan view. In other words, the embodiment shown in FIG. 5A is formed from multiple solar modules that are of the same size (e.g., the same length and width). In alternative embodiments, the solar modules can have different sizes, for example, a first set of solar modules of one size and a second set of solar modules of a different size. Such differing sized solar modules can be used with any of the other embodiments described herein.

In this example, the length of the three landscape-oriented solar modules 510a, 510b, 510c is less than the width of five portrait-oriented solar modules. Therefore, the solar array may include free ends 516 in which a portion of the frame is not affixed to the counterpart frame. However, the discrepancy is small and is unimportant at the end(s) of the rack, which are already “free” (i.e., not connected to any other solar module). Certain aspects of the solar array shown in FIGS. 5A-5B can be structurally and/or functionally similar to the solar array described in FIGS. 1A-1B, and therefore, certain aspects are not described herein with respect to FIGS. 5A-5B.

The tilt angles of the asymmetric portrait-landscape configuration can be altered. For example, the landscape solar modules need not be the same type as the portrait solar modules and may have different dimensions. For example, if the landscape solar modules are a smaller type of solar module, then the portrait modules are tilted less relative to the horizontal, and the landscape solar modules are tilted more than the embodiment shown in FIG. 3.

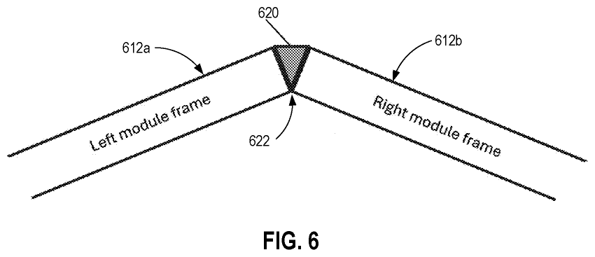

As shown in the example of FIG. 6, it is also possible to change the tilt angles of the asymmetric portrait-landscape configuration by putting an angled coupler 620 (e.g., angled extrusion, a metal angle, etc.) between the frames 612a, 612b of the solar modules along the ridgeline or apex line of the tent or inverted “V.” The angled coupler 620 can be, for example, a standard mass-produced metal angle (e.g., 135 degrees) or could be a purpose-made angle (e.g., an aluminum extrusion). Note that the metal angle shown in FIG. 6 is an example of an intervening component in contrast to the embodiment shown in FIG. 3 that does not have an intervening component between affixed solar panel fames (other than any device/component used for affixation such as hinge(s)). The frames 612a, 612b can form a 135-degree butt joint 622. Certain aspects of the solar array shown in FIG. 6 can be structurally and/or functionally similar to the solar array described in FIGS. 1A-1B, and therefore, certain aspects are not described herein with respect to FIG. 6.

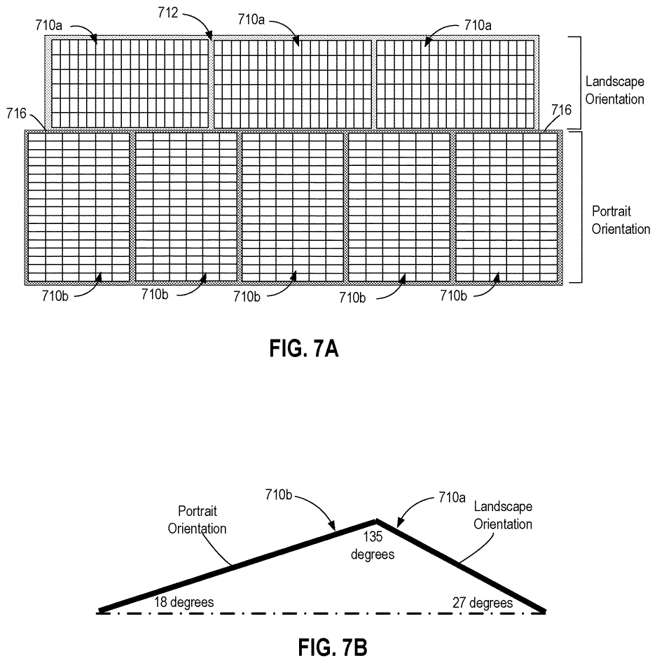

FIGS. 7A-7B shows the result if the asymmetric portrait-landscape configuration has a 135-degree included angle (rather than 90 degrees): the west-facing portion of the array 710b is now tilted at 18 degrees, while the east-facing portion 710a is tilted at 27 degrees, relative to a horizontal plane. Certain aspects of the solar array shown in FIGS. 7A-7B can be structurally and/or functionally similar to the solar array described in FIGS. 1A-1B, and therefore, certain aspects are not described herein with respect to FIGS. 7A-7B.

It should be appreciated that the various references herein to specific angle values (e.g., 90 degrees, 135 degrees, etc.) should be understood to also include those angle values plus or minus a small variation for example due to manufacturing and/or installation variances. In other words, any of the above references to a specific angle value, for example 90 degrees, should be understood to include angle values substantially that an angle value, for example substantially 90 degrees. Such manufacturing and/or installation variations can include angle values, for example, within 90%, 95%, 99%, etc. of the specified angle.

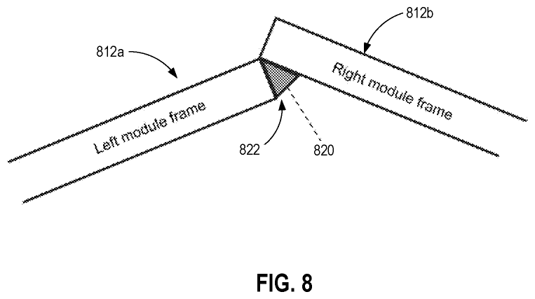

FIG. 8 is a side view of a solar array in which an inverted “V” shape is created by affixing the solar panel frames to an angled extrusion placed between them, according to an embodiment. In some implementations, a first frame 812a and a second frame 812b can be coupled via an angled coupler 820 (e.g., angled extrusion, a metal angle, etc.) to form a butt join 822 that is greater than 90 degrees (e.g., a 135-degree butt join). As described above, the angled coupler 820 can be, for example, a 45-degree metal angle and positioned such that the first frame 812a and the second from 812b form a butt join 822. In some embodiments, the angled coupler 820 can be positioned such that a first side of the angled coupler 820 abuts a side wall of the first frame 812a substantially orthogonal to the solar modules, and a second side of the angled coupler 820 abuts a bottom wall of the second frame 812b, or vice versa. Therefore, a portion of the second frame 812b may be stacked above a portion of the first frame 812a. Certain aspects of the solar array shown in FIG. 8 can be structurally and/or functionally similar to the solar array described in FIGS. 1A-1B, and therefore, certain aspects are not described herein with respect to FIG. 8. Additionally, certain aspects of the angled coupler 820 can be similar to any of the couplers (e.g., coupler 620) described herein.

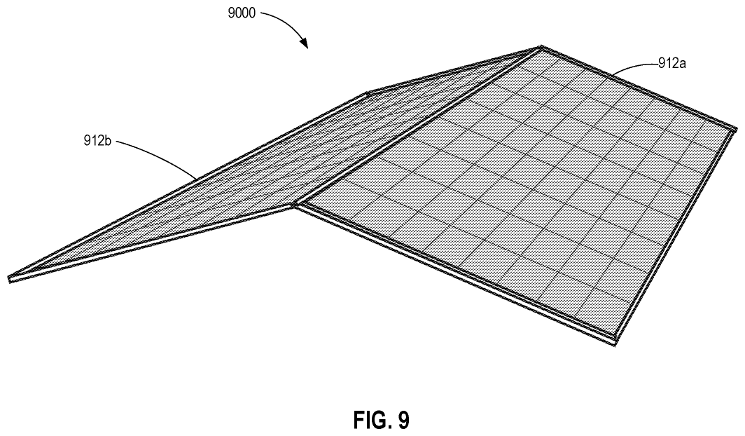

FIG. 9 shows an example of a solar array 9000, in which an inverted “V” shape is created by affixing solar panel frames 912a, 912b to each other at an angle greater than 90 degrees (e.g., 135 degrees). In some implementations, the solar panel frames 912a, 912b can be joined with an intervening component such as an angled coupler (e.g., shown in FIG. 6 or FIG. 8). In some implementations, the solar panel frames 912a, 912b can be coupled using one or more couplers (e.g., support structures, fasteners, hinges, etc.) (not shown in FIG. 9) in addition to or instead of the angled coupler. For example, FIG. 10 shows a solar panel array 10000 with a first solar panel array 1012a and a second solar panel array 1012b including one or more couplers (e.g., clips, clamps, etc.) 1024a, 1024b configured to hold the first frame 1012a and the second frame 1012b in place relative to one another. In some embodiments, fixedly attaching the first set of solar modules and the second set of solar modules can cause bending moments at the apex to be undesirably large. In some implementations, the first set of solar modules (or frame) 1012a can be coupled to the second set of solar modules (or frame) 1012b via one or more couplers (e.g., clips, clamps, mounts, hinges, etc.) 1024a, 1024b on one or more portions of the first frame 1012a or the second frame 1012b. For example, a first clamp 1024a can be configured to span across the apex to a portion of the first frame 1012a and a portion of the second frame 1012b to support or hold the first frame 1012a and the second frame 1012b relative to one another. In some implementations, the couplers 1024a, 1024b can extend along a portion of the short sides of the frames 1012a, 1012b to provide support to couple the frames at a predetermined angle. In some embodiments, the first frame 1012a and the second frame 1012b may not be affixed along the length of the apex AL, and the couplers 1024a, 1024b may support the first frame 1012a and the second frame 1012b in the desired geometry. However, in some implementations, the solar array 10000 can include the couplers 1024a, 1024b in addition to another coupler that affixes the frames 1012a, 1012b along a substantial length thereof.

As shown in FIG. 11, the solar array 11000 can include one or more couplers (e.g., fasteners, support structures, bars, rods, etc.) 1124 configured to be coupled between the sides of the frames that define the inverted “V.” As shown, the coupler 1124 is coupled to the short side of the first frame 1112a and a short side of the second frame 1112b and span across an opening defined by the first frame 1112a and the second frame 1112b. Therefore, the coupler 1124 can be configured to limit “splaying” of the “tent” formed by the frames 1112a, 1112b by reducing the bending moment at the apex once the tent is installed. In some implementations, there are two couplers 1124—one positioned at a first end of the tent structure 11000, as shown in FIG. 11, and one positioned at a second end, opposite the first end, of the tent structure 11000 (not visible in FIG. 11). In some implementations, the coupler 1124 can include a mechanical attachment that spans across an opening of the tent (e.g., the base of the tent). Although shown as being the short side of each frame 1112a, 1112b in FIG. 11, it should be appreciated that the first frame 1012a, 1112a and/or the second frame 1012b, 1112b can be positioned in a portrait orientation, and therefore, the coupler 1024, 1124 can be coupled to the long side of the first frame 1012a, 1112a and/or the second frame 1012b, 1112b.

As shown in FIG. 12, a solar array 12000 can include a coupler 1224 spanning between the first frame 1212a and the second frame 1212b. In some implementations, the coupler 1224 can include one or more hinges 1226 configured to allow the coupler 1224 to bend, buckle, move, or slide at one or more locations. Therefore, the coupler 1224 can be configured to hold the frames 1212a, 1212b to define different angles therebetween. In some implementations, the coupler 1224 can be coupled to a side of each frame 1212a, 1212b that define the inverted “V.” In some implementations, the coupler 1224 can be coupled to a central portion of the side of each frame 1212a, 1212b. In some implementations, the coupler 1224 can be coupled at or near a bottom section of the side of each frame 1212a, 1212b.

In some implementations, the solar arrays 10000, 11000, 12000 can include a first coupler 1024, 1124, 1224 on a first side of the inverted “V” to hold the first frame 1012a, 1112a, 1212a to the second frame 1012b, 1112b, 1212b. In some implementations, the solar arrays 10000, 11000, 12000 can include a first coupler 1024, 1124, 1224 on a first side of the inverter “V” and a second coupler (not shown) on a second side of the inverted “V” opposite the first side. In some embodiments, one coupler can be sufficient to reduce the moment arm on the apex and hold the solar array frames in the desired geometry (e.g., defining a predetermined angle). In some embodiments, the solar arrays can include couplers on both sides such that support is provided symmetrically.

FIG. 13 shows a perspective view of a solar array including one or more ground attachments, according to embodiments. In some implementations, the solar array 13000 can include one or more ground attachments 1330a, 1330b, 1330c, 1330d configured to hold one or more portions of the solar array 13000 in place (e.g., relative to the ground). In some implementations, the ground attachment(s) 1330a-1330b may be disposed at one or more bottom corners of the solar array 13000. For example, each bottom corner of the first frame 1312a can include ground attachments 1330a, 1330c, and each bottom corner of the second frame 1312b can include ground attachments 1330b, 1330d. In some implementations, each ground attachment 1330a can include a ground-anchored foot 1326 and a retaining clamp 1327. The retaining clamp 1327 can be configured to secure the ground-anchored foot 1326 from moving relative to the frame 1312a, 1312b.

Certain details of the solar arrays 9000, 10000, 11000, 12000, 13000 can be structurally and/or functionally similar to any of the solar arrays described herein, and therefore, certain details of the solar arrays 9000, 10000, 11000, 12000, 13000 are not described herein with respect to FIGS. 9-13.

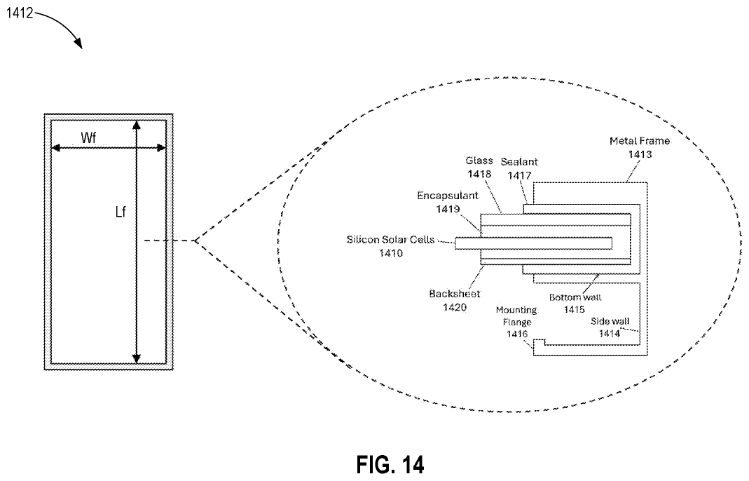

FIG. 14 shows a schematic of a metal frame 1412 of a solar array (left) and a close-up cross-section of layers of the metal frame 1412 (right), according to some embodiments. The metal frame 1412 can configured to hold one or more solar modules 1410. The metal frame 1412 can have a width Wf corresponding to a width of the solar modules and a length Lf corresponding to a length of the solar modules 1410. In some embodiments, the width Wf of the frame 1412 can be in a range between about 0.8 meters (m) to about 1.1 m, inclusive of all values and subranges therebetween. In some embodiments, the length Lf of the frame 1412 can be in a range between about 1.7 m and about 2.1 m, inclusive of all values and subranges therebetween.

As shown on the right of FIG. 14, the frame 1412 can include a first surface (e.g., top wall, lip, etc.) 1413, a side wall 1414, a second surface (e.g., bottom wall, lip, etc.) 1415, and a mounting flange 1416. The mounting flange 1416 can be configured to mount the frame 1412 to a solar racking system to position frame 1412 such that the solar modules face the sun. The frame 1412 can be mounted to the racking by using fasteners (e.g., bolts or the like) through openings in the mounting flange 1416, or by other methods such as using clamps to clamp around at least a portion of the frame 1412. Between the top wall 1413 and the bottom wall 1415, the frame 1412 can be configured to hold one or more layers including a seal 1417, a glass layer 1418, an encapsulant layer 1419, a solar module 1410 (e.g., silicon solar module), and a backsheet layer 1420. In some implementations, the solar module 1410 can be disposed between the backsheet layer 1420 and the encapsulant layer 1419.

The seal 1417, the encapsulant 1419, and/or the backsheet layer 1420 can protect the solar module 1410 from the elements (e.g., moisture in the air and/or rainwater). In some embodiments, the seal 1417 can include a sealant (adhesive, bonding material, glue, etc.) that can fix the solar components and the frame 1412 to one another. In some embodiments, the backsheet layer 1420 can include a multi-layer polymer laminate that can remain durable over long-term use of the solar array. The backsheet layer 1420 can include any suitable material such as, for example, polyvinyl fluoride (PVF) or polyvinylidene fluoride (PVDF) and polyethylene terephthalate (PET) polyester, glass, or any suitable combination thereof. In some embodiments, the backsheet layer 1420 can include a glass material that is the same or similar to the glass layer 1418, which can produce energy from light falling on either side of the solar module 1310. In some embodiments, the encapsulant layer 1419 can include any suitable transparent polymer film such as, for example, ethylene vinyl acetate (EVA), polyolefin elastomers (POE), thermoplastic polyolefins (TPO), silicone, or any suitable combination thereof. The encapsulant layer 1419 can adhere the solar module 1410 to the glass layer 1418 and the backsheet layer 1420 and inhibit moisture ingress between the layers. The encapsulant layer 1419 can also prevent movement of the solar modules 1419 (e.g., during transportation or during operations). In some implementations, the side wall 1414 can be configured to provide strength (support, stiffness, bending strength, etc.) to the solar module 1410 to prevent cracking of the solar modules 1410. In some implementations, the frame 1412 can include any suitable material such as metal (e.g., aluminum or steel) and/or polymers/plastic.

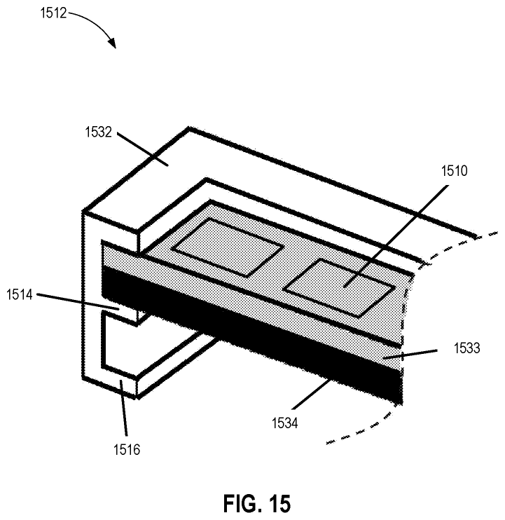

FIG. 15 shows another view of a cross-section of a solar module frame, according to another embodiment. The frame 1512 can include an outer portion and defining an opening in which the solar module 1510 can be partially disposed, allowing other portion(s) of the frame 1512 to be exposed. The frame 1512 can include a first lip or surface (e.g., a top surface) 1532 and a second lip or surface (e.g., bottom surface) 1514. The first surface 1532 and the second surface 1514 can be configured to receive the solar module 1510 therebetween to hold the solar module 1510 in place such that the solar module 1510 extends across the opening. The frame 1512 can additionally include a first layer of material 1533 (e.g., transparent material such as glass, plastic, etc.) and a second layer of material 1534 (e.g., transparent material such as glass, plastic, etc.), wherein the solar module 1510 is disposed between the first layer of material 1533 and the second layer of material 1534. The frame 1512 can further include a mounting flange 1516 the extends from the second (e.g., bottom) surface 1514 of the frame 1512.

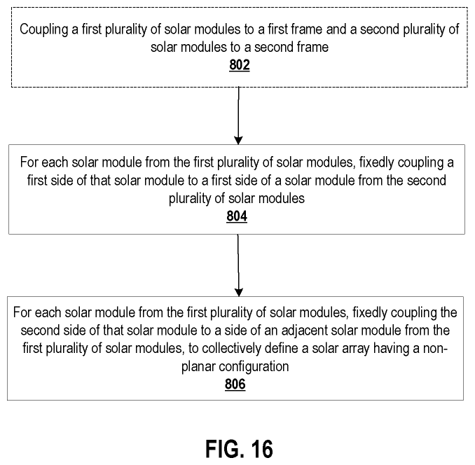

FIG. 16 is a flow chart of an example method of forming a non-planar solar array, according to embodiments. In some embodiments, the method can optionally include coupling a first plurality of solar modules to a first frame and a second plurality of modules to a second frame, at 802. In some embodiments, the method can include, for each solar module from a first plurality of solar modules, fixedly coupling a first side of that solar module to a first side of a solar module from a second plurality of solar modules, at 804. In some embodiments, the first side of the module from the first plurality of solar modules can be coupled along a substantial entirety thereof (e.g., along about 75%, or about 80%, or about 85%, or about 90%, or about 95%, or about 99% thereof). In some embodiments, each solar module from the first plurality of solar modules and/or the second plurality of solar modules can have the first side and a second side (e.g., adjacent to the first side). The method can include, for each solar module from the first plurality of solar modules, fixedly coupling the second side of that solar module to a side of an adjacent solar module from the first plurality of solar modules, to collectively define a solar array having a non-planar configuration, at 806. In some embodiments, the second side solar module from the first plurality of solar modules can be coupled along a substantial entirety thereof to the side of the adjacent solar module. Each solar module can have a planar configuration. In some embodiments, the first plurality of solar modules can be coupled to a first frame, and the second plurality of solar modules can be coupled to a second frame, and a first side of the frame can be coupled to a first side of the second frame.

In some embodiments, each solar module from the first plurality of solar modules and each solar module from the second plurality of solar modules can have a common (e.g., a substantially similar) size. In some embodiments, for each solar module from the first plurality of solar modules, the fixedly coupling the first side of that solar module includes fixedly and directly coupling the first side of that solar module to the first side of the solar module from the second plurality of solar modules without an intervening component. For example, the method can include forming a butt join between the first plurality of solar modules (e.g., the first frame) and the second plurality of solar modules (e.g., the second frame). In some embodiments, for each solar module from the plurality of first solar modules the fixedly coupling the first side of that solar module includes fixedly coupling the first side of that solar module to a first side of a spacer and fixedly coupling a second side of the spacer to the first side of the solar module from the second plurality of solar modules, and a side view of the spacer having an interior angle that defines an interior angle of the solar array from the side view. In some embodiments, a side view of the spacer having an interior angle that defines an interior angle of the solar array from the side view at substantially 135 degrees.

In some embodiments, the second side of each module of the first plurality of solar modules is shorter than the first side and the second side of each module of the second plurality of solar modules is shorter than the first side. In some embodiments, the first side of the solar modules are fixed to one another such that a side view of the solar array when positioned on a substantially planar surface has a first interior angle, a second interior angle and a third interior angle, the first interior angle is substantially 90 degrees, the second interior angle is substantially 45 degrees, and the third interior angle is substantially 45 degrees.

In some embodiments, the second side of each module of the first plurality of solar modules is shorter than the first side and the first side of each module of the second plurality of solar modules is shorter than the second side. In some embodiments, the first side of the solar modules are fixed to one another such that a side view of the solar array when positioned on a substantially planar surface has a first interior angle, a second interior angle and a third interior angle, the second interior angle is less than the first interior angle, the third interior angle is less than the first interior angle and the second interior angle. In some embodiments, the first side of the solar modules are fixed to one another such that a side view of the solar array when positioned on a substantially planar surface has a first interior angle, a second interior angle and a third interior angle, the first interior angle is substantially 90 degrees, the second interior angle is less than 45 degrees, and the third interior angle is greater than 45 degrees.

All combinations of the foregoing concepts and additional concepts discussed herewithin (provided such concepts are not mutually inconsistent) are contemplated as being part of the subject matter disclosed herein. The terminology explicitly employed herein that also may appear in any disclosure incorporated by reference should be accorded a meaning most consistent with the particular concepts disclosed herein.

The drawings primarily are for illustrative purposes and is not intended to limit the scope of the subject matter described herein. The drawings are not necessarily to scale; in some instances, various aspects of the subject matter disclosed herein can be shown exaggerated or enlarged in the drawing to facilitate an understanding of different features.

The acts performed as part of a disclosed method(s) can be ordered in any suitable way. Accordingly, embodiments can be constructed in which processes or steps are executed in an order different than illustrated, which can include performing some steps or processes simultaneously, even though shown as sequential acts in illustrative embodiments. Put differently, it is to be understood that such features can not necessarily be limited to a particular order of execution, but rather, any number of threads, processes, services, servers, and/or the like that can execute serially, asynchronously, concurrently, in parallel, simultaneously, synchronously, and/or the like in a manner consistent with the disclosure. As such, some of these features can be mutually contradictory, in that they cannot be simultaneously present in a single embodiment. Similarly, some features are applicable to one aspect of the innovations, and inapplicable to others.

In addition, the disclosure may include other innovations not presently described. Applicant reserves all rights in such innovations, including the right to embodiment such innovations, file additional applications, continuations, continuations-in-part, divisionals, and/or the like thereof. As such, it should be understood that advantages, embodiments, examples, functional, features, logical, operational, organizational, structural, topological, and/or other aspects of the disclosure are not to be considered limitations on the disclosure as defined by the embodiments or limitations on equivalents to the embodiments.

Where a range of values is provided, it is understood that each intervening value, to the tenth of the unit of the lower limit unless the context clearly dictates otherwise, between the upper and lower limit of that range and any other stated or intervening value in that stated range is encompassed within the disclosure. That the upper and lower limits of these smaller ranges can independently be included in the smaller ranges is also encompassed within the disclosure, subject to any specifically excluded limit in the stated range. Where the stated range includes one or both of the limits, ranges excluding either or both of those included limits are also included in the disclosure.

All definitions, as defined and used herein, should be understood to control over dictionary definitions, definitions in documents incorporated by reference, and/or ordinary meanings of the defined terms.

As used herein, in particular embodiments, the terms “substantially,” “about” or “approximately” when preceding a numerical value indicates the value plus or minus a range of 10%. Where a range of values is provided, it is understood that each intervening value, to the tenth of the unit of the lower limit unless the context clearly dictates otherwise, between the upper and lower limit of that range and any other stated or intervening value in that stated range is encompassed within the disclosure. That the upper and lower limits of these smaller ranges can independently be included in the smaller ranges is also encompassed within the disclosure, subject to any specifically excluded limit in the stated range. Where the stated range includes one or both of the limits, ranges excluding either or both of those included limits are also included in the disclosure.

The indefinite articles “a” and “an,” as used herein in the specification and in the embodiments, unless clearly indicated to the contrary, should be understood to mean “at least one.”

The phrase “and/or,” as used herein in the specification and in the embodiments, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements can optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the embodiments, “or” should be understood to have the same meaning as “and/or” as defined above. For example, when separating items in a list, “or” or “and/or” shall be interpreted as being inclusive, i.e., the inclusion of at least one, but also including more than one of a number or list of elements, and, optionally, additional unlisted items. Only terms clearly indicated to the contrary, such as “only one of” or “exactly one of,” or, when used in the embodiments, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of,” or “exactly one of.” “Consisting essentially of,” when used in the embodiments, shall have its ordinary meaning as used in the field of patent law.

As used herein in the specification and in the embodiments, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements can optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the embodiments, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

What is claimed is:

1. An apparatus, comprising:
a first plurality of solar modules, each solar module from the first plurality of solar modules having a planar configuration and having a first side and a second side shorter than the first side; and
a second plurality of solar modules coupled to the first plurality of solar modules, each solar module from the second plurality of solar modules having a planar configuration and having a first side and a second side,
for each solar module from the first plurality of solar modules, (1) the first side of that solar module being fixedly coupled to and along a substantial entirety of the first side of a solar module from the second plurality of solar modules, and (2) the second side of that solar module being fixedly coupled to and along a substantial entirety of a side of an adjacent solar module from the first plurality of solar modules, the first plurality of solar modules and the second plurality of solar modules collectively defining a solar array having a non-planar configuration.

2. The apparatus of claim 1, wherein:
each solar module from the first plurality of solar modules and each solar module from the second plurality of solar modules has a common size,
for each solar module from the second plurality of solar modules, the second side is shorter than the first side of that solar module, and
a side view of the solar array when positioned on a substantially planar surface has a first interior angle, a second interior angle and a third interior angle, the first interior angle is substantially 90 degrees, the second interior angle is not less than 45 degrees, and the third interior angle is not greater than 45 degrees.

3. The apparatus of claim 2, wherein:
for each solar module from the first plurality of solar modules, the first side of that solar module is fixedly and directly coupled to the first side of the solar module from the second plurality of solar modules without an intervening component.

4. The apparatus of claim 1, wherein:
each solar module from the first plurality of solar modules and each solar module from the second plurality of solar modules has a common size,
for each solar module from the second plurality of solar modules, the first side is shorter than the second side of that solar module, and
a side view of the solar array when positioned on a substantially planar surface has a first interior angle, a second interior angle and a third interior angle, the first interior angle is substantially 90 degrees, the second interior angle is less than 45 degrees, and the third interior angle is greater than 45 degrees.

5. The apparatus of claim 4, wherein:
for each solar module from the first plurality of solar modules, the first side of that solar module is fixedly and directly coupled to the first side of a solar module from the second plurality of solar modules without an intervening component.

6. The apparatus of claim 1, wherein:
each solar module from the first plurality of solar modules and each solar module from the second plurality of solar modules has a common size,
for each solar module from the second plurality of solar modules, the first side is shorter than the second side of that solar module, and
a side view of the solar array when positioned on a substantially planar surface has a first interior angle, a second interior angle and a third interior angle, the second interior angle is less than the first interior angle, the third interior angle is less than the first interior angle and the second interior angle.

7. The apparatus of claim 6, wherein:
for each solar module from the first plurality of solar modules:
the first side of that solar module is fixedly coupled to a first side of a spacer that has a second side fixedly coupled to the first side of the solar module from the second plurality of solar modules, and
a side view of the spacer having an interior angle that defines an interior angle of the solar array from the side view.

8. The apparatus of claim 6, wherein:
for each solar module from the first plurality of solar modules:
the first side of that solar module is fixedly coupled to a first side of a spacer that has a second side fixedly coupled to the first side of the solar module from the second plurality of solar modules,
a side view of the spacer having an interior angle that defines an interior angle of the solar array from the side view at substantially 135 degrees.

9. The apparatus of claim 1, wherein:
each solar module from the first plurality of solar modules has a first size, each solar module from the second plurality of solar modules has a second size different from the first size, and
for each solar module from the second plurality of solar modules, the second side of that solar module is shorter than the first side of that solar module.

10. The apparatus of claim 1, wherein:
each solar module from the first plurality of solar modules has a first size, each solar module from the second plurality of solar modules has a second size different from the first size, and
for each solar module from the second plurality of solar modules, the first side of that solar module is shorter than the second side of that solar module.

11. A method, comprising:
for each solar module from a first plurality of solar modules, fixedly coupling a first side of that solar module along a substantial entirety thereof to a first side of a solar module from a second plurality of solar modules,
each solar module from the first plurality of solar modules having a planar configuration and having a first side and a second side shorter than the first side; and
each solar module from the second plurality of solar modules having a planar configuration and having a first side and a second side; and
for each solar module from the first plurality of solar modules, fixedly coupling the second side of that solar module along a substantial entirety thereof to a side of an adjacent solar module from the first plurality of solar modules, to collectively define a solar array having a non-planar configuration.

12. The method of claim 11, wherein:
each solar module from the first plurality of solar modules and each solar module from the second plurality of solar modules has a common size,
for each solar module from the second plurality of solar modules, the second side is shorter than the first side of that solar module, and
a side view of the solar array when positioned on a substantially planar surface has a first interior angle, a second interior angle and a third interior angle, the first interior angle is substantially 90 degrees, the second interior angle is substantially 45 degrees, and the third interior angle is substantially 45 degrees.

13. The method of claim 12, wherein:
for each solar module from the first plurality of solar modules, the fixedly coupling the first side of that solar module includes fixedly and directly coupling the first side of that solar module to the first side of the solar module from the second plurality of solar modules without an intervening component.

14. The method of claim 11, wherein:
each solar module from the first plurality of solar modules and each solar module from the second plurality of solar modules has a common size,
for each solar module from the second plurality of solar modules, the first side is shorter than the second side of that solar module, and
a side view of the solar array when positioned on a substantially planar surface has a first interior angle, a second interior angle and a third interior angle, the first interior angle is substantially 90 degrees, the second interior angle is less than 45 degrees, and the third interior angle is greater than 45 degrees.

15. The method of claim 14, wherein:
for each solar module from the first plurality of solar modules, the fixedly coupling the first side of that solar module includes fixedly and directly coupling the first side of that solar module to the first side of the solar module from the second plurality of solar modules without an intervening component.

16. The method of claim 11, wherein:
each solar module from the first plurality of solar modules and each solar module from the second plurality of solar modules has a common size,
for each solar module from the second plurality of solar modules, the first side is shorter than the second side of that solar module, and
a side view of the solar array when positioned on a substantially planar surface has a first interior angle, a second interior angle and a third interior angle, the second interior angle is less than the first interior angle, the third interior angle is less than the first interior angle and the second interior angle.

17. The method of claim 16, wherein:
for each solar module from the first plurality of solar modules:
the fixedly coupling the first side of that solar module includes fixedly coupling the first side of that solar module to a first side of a spacer and fixedly coupling a second side of the spacer to the first side of the solar module from the second plurality of solar modules, and
a side view of the spacer having an interior angle that defines an interior angle of the solar array from the side view.

18. The method of claim 16, wherein:
for each solar module from the first plurality of solar modules:
the fixedly coupling the first side of that solar module includes fixedly coupling the first side of that solar module to a first side of a spacer and fixedly coupling a second side of the spacer to the first side of the solar module from the second plurality of solar modules,
a side view of the spacer having an interior angle that defines an interior angle of the solar array from the side view at substantially 135 degrees.

19. The method of claim 11, wherein:
each solar module from the first plurality of solar modules has a first size, each solar module from the second plurality of solar modules has a second size different from the first size, and
for each solar module from the second plurality of solar modules, the second side of that solar module is shorter than the first side of that solar module.

20. The method of claim 11, wherein:
each solar module from the first plurality of solar modules has a first size, each solar module from the second plurality of solar modules has a second size different from the first size, and
for each solar module from the second plurality of solar modules, the first side of that solar module is shorter than the second side of that solar module.
